(19) United States
(12) Patent Application Publication
(10) Pub. No.: US 2011/0043750 A1
(43) Pub. Date: Feb. 24, 2011

(54) SEAMLESS BIFOCAL LENS

(76) Inventor: Tsung-Meng Tsai, Tainan City (TW)

Correspondence Address: STEPTOE & JOHNSON LLP, 1330 CONNECTICUT AVENUE, N.W., WASHINGTON, DC, 20036, US

(21) Appl. No.: 12/859,704

(22) Filed: Aug. 19, 2010

(30) Foreign Application Priority Data
Aug. 20, 2009 (TW) 098215403

(51) Int. Cl. G02C 7/06

(52) U.S. Cl. 351/168

(57) ABSTRACT

A seamless bifocal lens comprises a plain glass portion, and a near vision region molded integrally with and protruding from a lower part of the plain glass portion. The near vision region has a central part, a border connected to the plain glass portion and surrounding the central part, and a protruding surface that protrudes gradually from the border to the central part. The protruding surface has a thickness that, increases from the border to the central part.

### CROSS-REFERENCE TO RELATED APPLICATION

This application claims priority of Taiwanese Application No. 098215403, filed on Aug. 20, 2009.

### BACKGROUND OF THE INVENTION

1. Field of the Invention

This invention relates to an eyeglass lens, and more particularly to a seamless bifocal lens.

2. Description of the Related Art

Referring to FIGS. 1 and 2, a lens 1 of a conventional pair of reading glasses includes a main body portion 11, and a convex lens portion 12 protruding from the main body portion 11. The main body portion 11 is plain glass, while the convex lens portion 12 is used for correcting vision. The convex lens portion 12 has a first surface 121 extending horizontally and perpendicularly from a surface of the main body portion 11, and a second surface 122 extending downwardly and curvedly from an outer end of the first surface 121 to connect with the main body portion 11. The user can see distant objects using the planar main body portion 11, and close objects using the convex lens portion 12.

Referring to Fig . 3, a method for making the lens 1 includes the steps of using a primary mold 21 for forming the main body portion 11, and a secondary mold 22 mounted within the primary mold 21 for forming the convex lens portion 12. The primary and secondary molds 21, 22 respectively have cavities 210, 220 communicating with each other. During injection molding, the main body portion 11 and the convex lens portion 12 can be formed simultaneously. Since the secondary mold 22 is replaceable, a suitable secondary mold 22 can be mounted within the primary mold 21 to produce a different degree of lens 1. Hence, different degrees of lenses 12 can be produced using the aforesaid method.

However, since the outer end of the first surface 121 of the convex lens portion 12 is spaced apart from the surface of the main body portion 11 to form a stepped structure, the convex lens portion 12 can be clearly seen as being distinct from the lens 1. Further, with reference to FIGS. 3 and 4, the lens 1 is formed by first interconnecting the primary and secondary molds 21, 22 and then performing the injection molding process. Because the molds are independent relative to each other, and although the main body portion 11 and the convex lens portion 12 are formed integrally as one body, a trace of protrusion 120 is formed between a junction of the second surface 122 of the convex lens portion 12 and the main body portion 11, as shown in FIG. 4. The protrusion 120 is formed in a gap 210 between a junction or joint line of the primary and secondary molds 21, 22.

From the aforesaid description, it is apparent that the conventional lens 1 has obvious borderlines that adversely affect the appearance of the lens 1 and the vision of a wearer.

### SUMMARY OF THE INVENTION

Therefore, the object of the present invention is to provide a seamless bifocal lens that is capable of overcoming the aforementioned drawbacks of the prior art.

According to this invention, a seamless bifocal lens comprises a plain glass portion, and a near vision region molded integrally with and protruding from a lower parₜ of the plain glass portion. The near vision region has a central part, a border connected to the plain glass portion and surrounding the central part, and a protruding surface that protrudes gradually from the border to the central part. The protruding surface has a thickness that increases from the border to the central part.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic front view of a conventional bifocal lens;

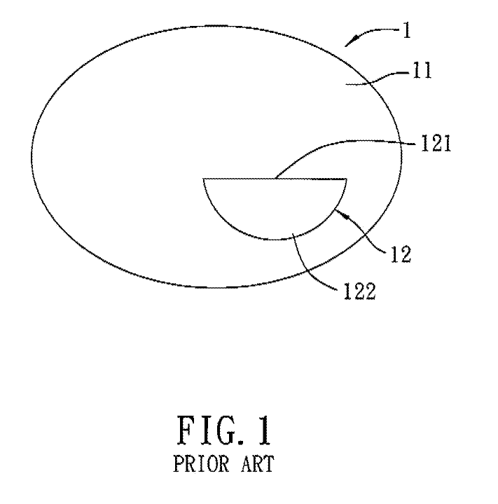

FIG. 2 is a sectional side view of the conventional bifocal lens;

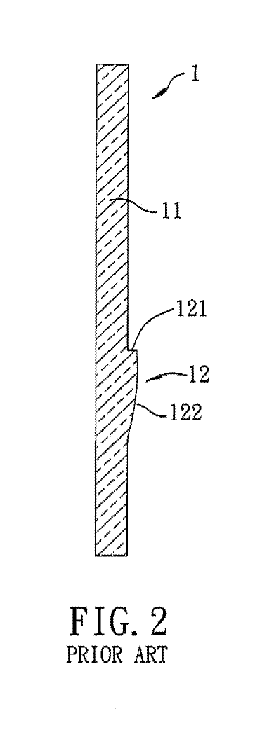

FIG. 3 is a fragmentary sectional view, illustrating use of primary and secondary molds to form the lens of FIG. 2;

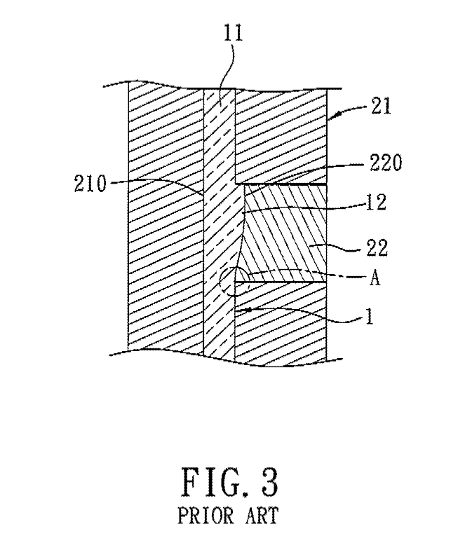

FIG. 4 is an enlarged fragmentary sectional view of an encircled portion of FIG. 3;

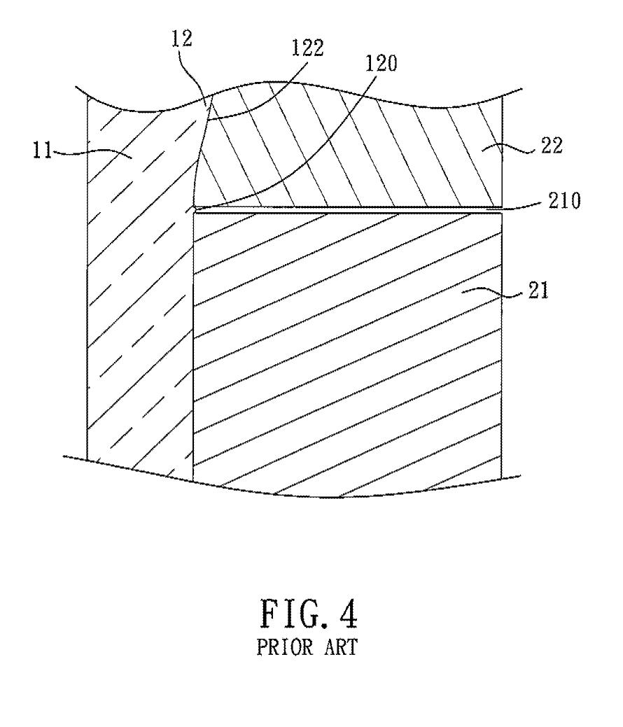

FIG. 5 is a schematic front view of a seamless bifocal lens according to the first preferred embodiment of this invention;

FIG. 6 is a fragmentary sectional view of the first preferred embodiment;

FIG. 7 is a fragmentary sectional view, illustrating use of a mold to form the first preferred embodiment;

FIG. 8 is a schematic front view of a seamless bifocal lens according to the second preferred embodiment of this invention; and

FIG. 9 is a fragmentary sectional view of the second preferred embodiment.

### DETAILED DESCRIPTION OF THE PREFERRED EMBODIMENTS

Before the present invention is described in greater detail, it should be noted that the same reference numerals have been used to denote like elements throughout the specification.

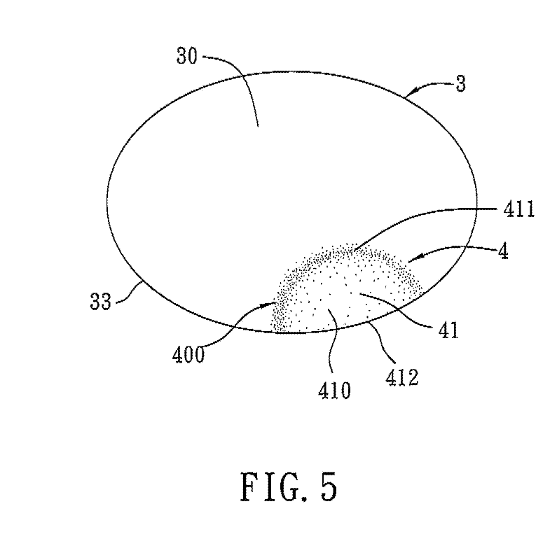

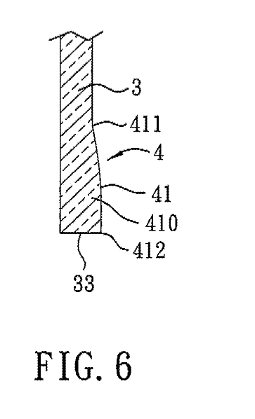

Referring to FIGS. 5 and 6, a seamless bifocal lens according to the first preferred embodiment of this invention is shown to comprise a plain glass portion 3 and a near vision region 4.

The plain glass portion 3 defines a distance vision region 30, and has a looped peripheral edge 33 surrounding the distance vision region 30. Although a plain glass has zero degrees, in this embodiment, the plain glass portion 3 may range from 0 to 6 degrees, where 100 degrees are equivalent to one diopter. As long as the lens has below 6 degrees, it will not affect the vision of the wearer, and is still similar to a lens with a zero degree.

The near vision region 4 is molded integrally with the plain glass portion 3, and is disposed on a lower part of the distance vision region 30. The near vision region 4 is a convex lens region, and has a degree of, for example, 100, 200, etc. , for correcting the strength of vision of the wearer of a reading glass. The near vision region 4 has a central part 410, a border 400, and a protruding surface 41. In this embodiment, the border 400 includes an upper border 411 that is connected to the distance vision region 30 and that is arched around the central part 410, and a lower border 412 that is connected to two opposite ends of the upper border 411 and that coincides with a bottom section of the looped peripheral edge 33. The upper and lower borders 411, 412 surround the central part 410. The protruding surface 41 protrudes gradually from the upper border 411 to the lower border 412. Because the connection between the distance vision region 30 and the near vision region 4 is gradual, the upper border 411 that interconnects the distance vision region 30 and the near vision region 4 is not easily noticeable. Further, the lower border 412 serves as a boundary between the near vision region 4 and the atmosphere or other components bordering.

The near vision region 4 has a thickness that increases gradually from the upper border 411 to the lower border 412. That is, the near vision region 4 has the largest thickness at the lower border 412. The largest thickness is about 1 mm. The near vision region 4 is adapted to be located adjacent to the nose portion of the wearer to permit the wearer to clearly see near objects. Hence, the near vision region 4 is disposed adjacent to one of the left and right bottom sides of the distance vision region 30.

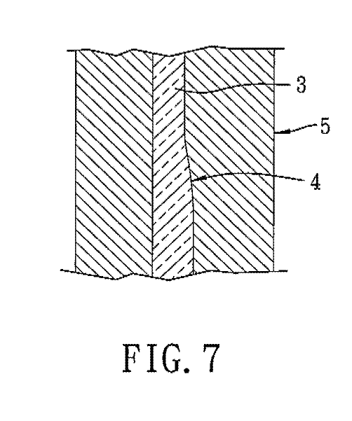

With reference to FIGS. 5, 6, and 7, the bifocal lens of the present invention is made integrally into a one-piece body using a single mold 5 by an injection molding process. After injection molding, the lens undergoes a suitable process to form a predetermined shape and a cutting process so that the lower border 412 of the near vision region 4 becomes a bottommost edge of the entire lens. Although the near vision region 4 is thicker than the plain glass portion 3, because the near vision region 4 gradually protrudes from the upper border 411 which is connected to the distance vision region 30 of the plain glass portion 3, there is no seam between the near vision region 4 and the distance vision region 30. Further, the largest thickness of the near vision region 4 is at the lower border 412 which coincides with the bottom section of the looped peripheral edge 33, so that the plain glass portion 3 and the near vision region 4 forms an integral seamless body.

In summary, since the upper border 411 smoothly interconnects the plain glass portion 3 and the near vision region 4, and since the thickness of the near vision region 4 increases gradually from the upper border 411 to the lower border 412 with the largest thickness thereof being at the lower border 412 which coincides with the bottom section of the looped peripheral edge 33, the lens of the present invention, as a whole, forms an integral seamless body. Hence, the appearance of the lens of the present invention is more appealing than that of the conventional lens. Further, the wearer is not affected when viewing objects during use of the lens because there is no seam appearing on the lens of the present invention.

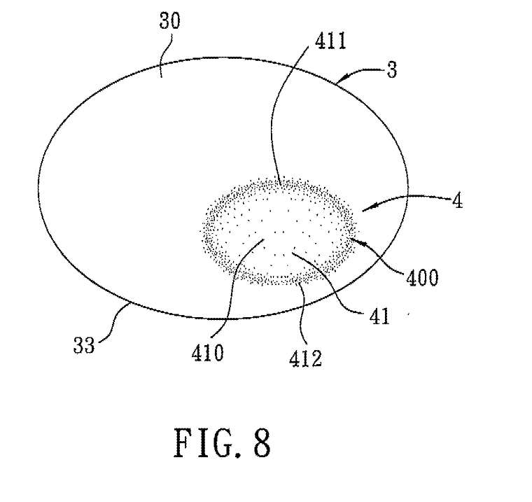

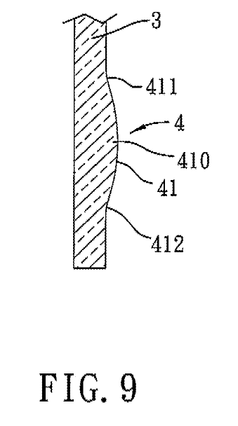

Referring to FIGS. 8 and 9, a seamless bifocal lens according to the second preferred embodiment of this invention is shown to be similar to the first preferred embodiment. However, in this embodiment, the near vision region 4 is disposed within the distance vision region 30 such that the lower border 412 does not coincide with the bottom section of the looped peripheral edge 33, and the border 400 is looped around the central part 410 of the near vision region 4. Further, the thickness of the near vision region 4 increases gradually from the upper border 411 to the central part 410, and decreases gradually from the central part 410 to the lower border 412, so that the largest thickness of the near vision region 4 is at the center of the central part 410. The near vision region 4 has an elliptical shape when viewed from a front side, as illustrated in FIG. 8.

In this embodiment, the lens is similarly formed integrally as a one-piece body using a single mold. Since the thickness of the near vision region 4 increases gradually from the border 400 to the center of the central part 410 thereof, the structure of the lens is stepless at a connection between the near vision region 4 and the plain glass portion 3, so that the near vision region 4 and the plain glass portion 3 presents a seamless unitary body.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

We claim:

1. A seamless bifocal lens, comprising:
a plain glass portion; and
a near vision region molded integrally with and protruding from a lower part of said plain glass portion, said near vision region having a central part, a border connected to said plain glass portion and surrounding said central part, and a protruding surface that protrudes gradually from said border to said central part, said protruding surface having a thickness that increases from said border to said central part.

2. The seamless bifocal lens of claim 1, wherein said plain glass portion has a looped peripheral edge surrounding said near vision region, and said border of said near vision region includes an upper border that is arched around said central part, and a lower border that coincides with a bottom section of said looped peripheral edge, said upper and lower borders surrounding said central part.

3. The seamless bifocal lens of claim 2 , wherein the thickness of said near vision region increases gradually from said upper border to said lower border, the thickness being the largest at said lower border.

4. The seamless bifocal lens of claim 1, wherein said border of said near vision region is looped around said central part, and the thickness of said near vision region increases gradually from said border to the center of said central part.
